(19) United States
(12) Patent Application Publication
(10) Pub. No.: US 2026/0118644 A1
(43) Pub. Date: Apr. 30, 2026

(54) OPTICAL ELEMENT AND OPTICAL APPARATUS

(71) Applicant: CANON KABUSHIKI KAISHA, Tokyo (JP)

(72) Inventor: Genichiro KUDO, Tochigi (JP)

(21) Appl. No.: 19/362,593

(22) Filed: Oct. 20, 2025

(30) Foreign Application Priority Data
Oct. 28, 2024 (JP) 2024-189016

(51) Int. Cl. G02B 13/00; G02B 5/30; G02B 27/01; G02B 1/04

(52) U.S. Cl. CPC G02B 13/006; G02B 5/3083; G02B 27/0172; G02B 1/041; G02B 2027/011; G02B 2027/0132

(57) ABSTRACT

An optical element includes a first optical element, and a second optical element that is a film. At least one surface of the first optical element has a first area as an optically effective portion and a second area as an ineffective portion. The optically effective portion is an effective diameter of a light ray to be actually used, and the ineffective portion is at least a part on an outer periphery side of the optically effective portion. The first area forms a cementing surface to which the second optical element is cemented. A predetermined inequality is satisfied.

### BACKGROUND

### Field of the Technology

The aspect of the disclosure relates to one or more embodiments of an optical element for a display apparatus, such as a head-mounted display (HMD).

### Description of the Related Art

Commonly used optical elements include a cemented lens made by cementing two resin lenses together, and a cemented lens made by cementing a resin lens and a polarizing film together. A typical film cementing method is known to be to cement a film in air or vacuum to a surface of a lens formed by injection molding or the like.

One of the purposes for using a cemented lens is size reduction. In the optical system in a VR display apparatus, in which a film or lens is placed close to the viewer's eye like glasses, the lens or film is cemented together to reduce space and achieve a wide angle.

To reduce the apparatus size, it is necessary to cement a film to the entire effective area of the lens and to reduce the diameter of the cemented lens. It is therefore known that vacuum forming, compressed air forming, press molding, etc. are required to manufacture an inexpensive film-cemented resin lens (see Japanese Patent Application Laid-Open No. 09-258009).

### SUMMARY

One or more embodiments of an optical element according to one or more aspects of the disclosure may include a first optical element, and a second optical element that is a film. At least one surface of the first optical element has a first area as an optically effective portion and a second area as an ineffective portion. The optically effective portion is an effective diameter of a light ray to be actually used, and the ineffective portion is at least a part on an outer periphery side of the optically effective portion. The first area forms a cementing surface to which the second optical element is cemented. The following inequality is satisfied: C < D where C is a size of the first area, and D is an external size of the second optical element. One or more display apparatuses may include one or more optical element in accordance with one or more other aspects of the disclosure.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic diagram of an R1 surface of a lens according to Example 1.

FIG. 2 is a cross-sectional view of the lens according to Example 1.

FIG. 3 is an enlarged view of an end of the lens according to Example 1.

FIG. 4 is a schematic diagram of an R2 surface of the lens according to Example 1.

FIG. 5 is a schematic diagram of an R1 surface of a lens according to Example 2.

FIG. 6 is a cross-sectional view of the lens according to Example 2.

FIG. 7 is an enlarged view of an end of the lens according to Example 2.

FIG. 8 is a schematic diagram of an R2 surface of the lens according to Example 2.

FIG. 9 is a schematic diagram of an R1 surface of a lens according to Example 3.

FIG. 10 is a cross-sectional view of the lens according to Example 3.

FIG. 11 is an enlarged view of an end of the lens according to Example 3.

FIG. 12 is a schematic diagram of an R2 surface of the lens according to Example 3.

FIG. 13 is a cross-sectional view of a cemented lens according to Example 4.

FIG. 14 is an enlarged view of an end of the lens according to Example 4.

FIG. 15 is a cross-sectional view of a display optical system.

FIG. 16 illustrates a display apparatus.

### DESCRIPTION OF THE EMBODIMENTS

Referring now to the accompanying drawings, a description will be given of examples according to the disclosure.

### EXAMPLE 1

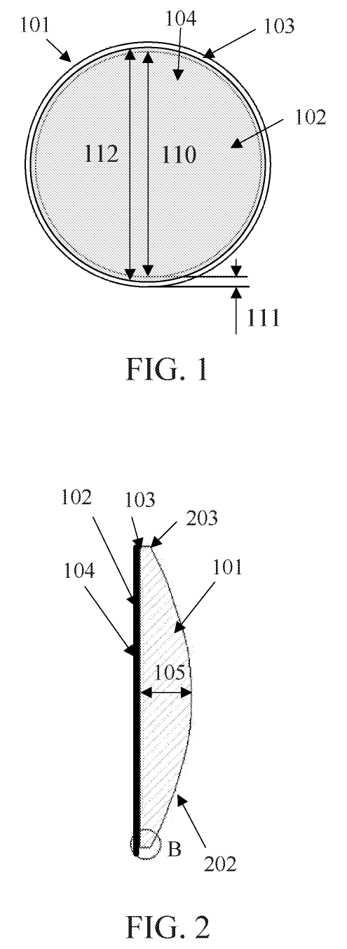

FIG. 1 illustrates a schematic diagram of an optical element according to Example 1 of the disclosure.

A lens 101 as a first optical element has an optically effective portion 102 and an ineffective portion 103 on the lens surface. The optically effective portion 102 is (or determines) an effective diameter of a light ray to be actually used. The ineffective portion 103 is at least a part on an outer periphery side of the optically effective portion 102, A quarter-wave film (referred to as a “film” hereinafter) 104 as a quarter waveplate is also cemented to the surface. The film 104 as a second optical element is cemented so that its diameter 112 is larger than a diameter 110 of the optically effective portion 102 and smaller than the outer diameter of the lens 101.

That is, the diameter (external size D) 112 of the film 104 as the second optical element, the diameter (size C) 110 of the optically effective portion 102 as the first area, and the width (size E) 111 of the ineffective portion 103 as the second area may satisfy the following inequality: 110 < 112 < (110 + 111).

That is, the following inequality may be satisfied: C < D < (C + E)

FIG. 2 illustrates a schematic cross section of the lens 101 illustrated in FIG. 1. The lens 101 is a concave-convex lens, with a radius of curvature R1 of R1 surface = -800 mm, a radius of curvature R2 near the center of R2 surface = -35.7 mm, and a central thickness 105 of 7.0 mm.

The film 104 is adhered (cemented) to the optically effective portion 102 of the R1 surface via an adhesive layer. As described above, the film 104 is configured so that its diameter is larger than that of optically effective portion 102, and is adhered so that its ends extend beyond the optically effective portion 102. Reference numeral 202 denotes the optically effective portion of the R2 surface, and reference numeral 203 denotes the ineffective portion of the R2 surface. The R2 surface is a refractive surface with convex power.

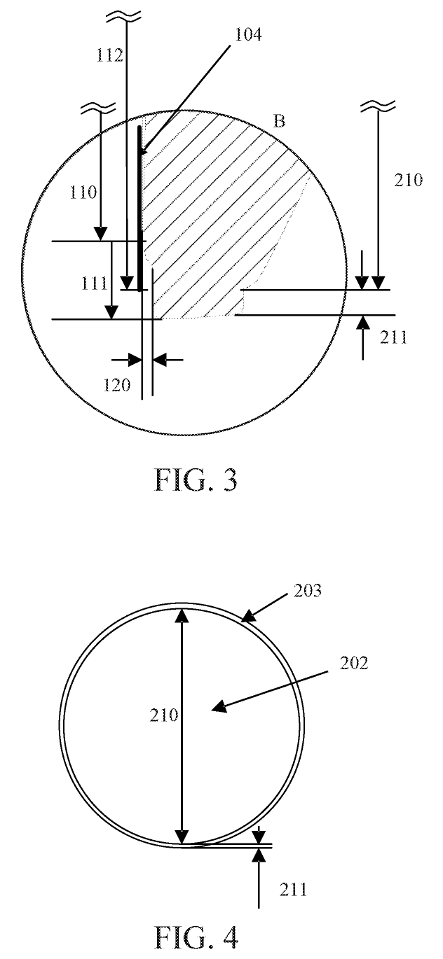

FIG. 3 illustrates an enlarged view of end B of the lens illustrated in FIG. 2. The end of the R1 surface of the lens 101 has a step with a step height 120 in the optical axis direction at the boundary between the optically effective portion 102 and the ineffective portion. In this example, the step height 120 is 0.15 mm. This is to prevent protrusions such as a burr that occurs during lens molding from coming into contact with the film 104.

In FIG. 3, the diameter 112 of the film 104 is set to be larger than that of the optically effective portion 102, and the film 104 protrudes into the ineffective portion 103. Thereby, the film 104 can be attached to the entire optically effective portion 102. Since the optically effective portion 102 and the ineffective portion 103 are different in height in the optical axis direction, even if there is a protrusion such as a burr on the lens, the film 104 is prevented from riding up on the burr, and causing the occurrence of a defective product such as a non-adhered portion of the film 104 or peeling of the film 104 from the optically effective portion 102.

If the step height Ht (120) in the optical axis direction between the optically effective portion 102 and the ineffective portion 103 is 0.15 mm as described above, and the lens thickness d (central thickness of the lens) is 7.0 mm, then Ht/d = 0.15/7 = 0.021, which satisfies the inequality 0.005 < Ht/d < 0.500. Thereby, the film 104 that is larger than the optically effective portion 102 can be attached.

A burr is generated in the optical axis direction on the lens 101 because resin flows between the mold that forms the optically effective portion 102 and the mold that forms the ineffective portion 103. Therefore, the outer circumferential portion (outer periphery) of the mold that forms the optically effective portion 102 may have a step. In this case, if the inequality 0.005 < Ht/d < 0.200 is satisfied, the step amount can be reduced, which is beneficial in terms of mold processing. In a case where the inequality 0.005 < Ht/d < 0.1000 is satisfied, manufacturing becomes easier.

FIG. 4 illustrates the shape of the R2 surface. The R2 surface includes an optically effective portion 202 and an ineffective portion 203, similarly to the R1 surface, and the optically effective portion 202 has a diameter 210 and the ineffective portion 203 has a width of 211. A step is provided between the optically effective portion 202 and the ineffective portion 203 in the optical axis direction. Thereby, even if a burr is generated at the boundary between the optically effective portion 202 and the ineffective portion 203, the entire area of the optically effective portion 202 can be used as an optical surface when the lens is cemented, and the size of the lens can be reduced.

In this example, since the outer shape of the lens 101 is approximately circular, its size is defined by its diameter, but if the outer shape is noncircular, the diameter 110 of the minor and major axes of the optically effective portion 102, the diameter 112 of the minor and major axes of the film 104, and the width 111 of the ineffective portion 103 may satisfy the following inequality: 110 < 112 < (110 + 111)

In this example, the lens material is plastic, which reduces the cost of the lens 101. Examples of plastic materials include polycarbonate (PC), polyester (PEs), (meth)acrylic (PMMA), cycloolefin polymer (COP), and cycloolefin copolymer (COC).

The film 104 is made by stretching a film made of COP, COC, or PC in a predetermined direction. The film 104 has a slow axis and a fast axis perpendicular to it, and can delay the phase of light that enters parallel to the slow axis by a specific wavelength before outputting it.

The directions of the slow axis and fast axis of the film 104 can be confirmed, for example, from the orientation angle calculated when birefringence is measured, and the direction with an orientation angle of 0° is the fast axis, and the direction perpendicular to the fast axis is the slow axis. Examples of the film 104 include a half-wave film (half waveplate) that can delay the phase of light incident parallel to the slow axis by a half wavelength, a quarter-wave film (quarter waveplate) that can delay the phase of light incident parallel to the slow axis by a quarter wavelength, and another phase film.

The phase films made of COP or COC are known to have small variations in birefringence in terms of stretching of the phase film, but the adhesive strength with the adhesive layer is weak and the adhesive strength with the lens is inferior. On the other hand, the phase films made of PC are known to have large variations in birefringence in terms of stretching of the phase film, but the adhesive strength with the adhesive layer is strong and the adhesive strength with the lens is superior.

As described above, devising the shape of the lens 101 to make the film 104 larger than the optically effective portion 102 can produce an inexpensive and small phase film cemented lens without enlarging the lens 101.

### EXAMPLE 2

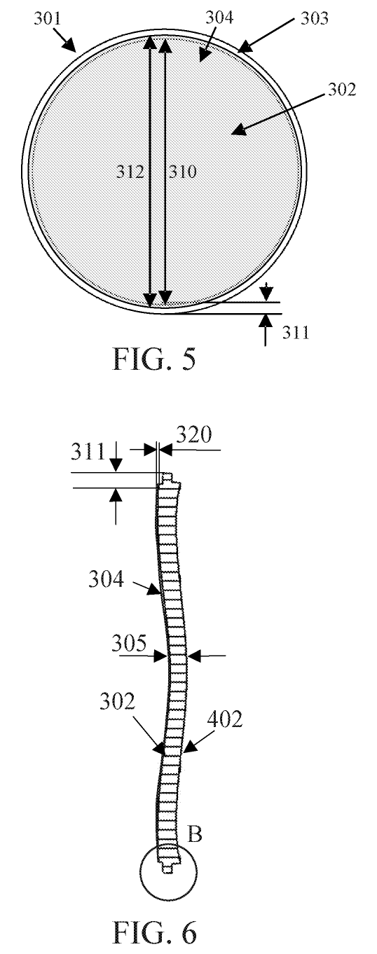

FIGS. 5 to 8 schematically illustrate a lens 301 according to Example 2. This example differs from Example 1 in the shape of lens 301 and the configuration of the film.

In FIG. 5, the lens 301 includes an optically effective portion 302 and an ineffective portion 303 on the lens surface. A reflective polarizing film 304 is attached to the surface as a reflective polarizing element. The reflective polarizing film 304 functions as a polarizing beam splitter (PBS) that reflects P-polarized light and transmits S-polarized light. A diameter 312 of the reflective polarizing film 304 is set to be larger than a diameter 310 of the optically effective portion 302 and smaller than an outer diameter of the lens 301. In other words, the diameter 312 of the film 304, the diameter 310 of the optically effective portion 302, and the width 311 of the ineffective portion 303 may satisfy the following inequality: 310 < 312 < (310 + 311)

FIG. 6 illustrates a schematic cross-section of lens 301 illustrated in FIG. 5. The lens 301 is a concave-convex lens, and is a resin lens with a radius of curvature R1 = -38.1 mm near the center of R1 surface, a radius of curvature R2 = -44.9 mm near the center of R2 surface, and a center thickness 305 of 1.8 mm. The reflective polarizing film 304 is adhered (cemented) to the optically effective portion 302 of the R1 surface via an adhesive layer.

As described above, the reflective polarizing film 304 has a larger diameter than that of the optically effective portion 302, and is adhered to the R1 surface so that its ends extend beyond the optically effective portion 302. Reference numeral 402 denotes the optically effective portion of R2 surface, and reference numeral 403 denotes the ineffective portion of R2 surface. The R2 surface is a refractive surface with convex power, and an antireflection coating (not illustrated) is vapor-deposited on its surface.

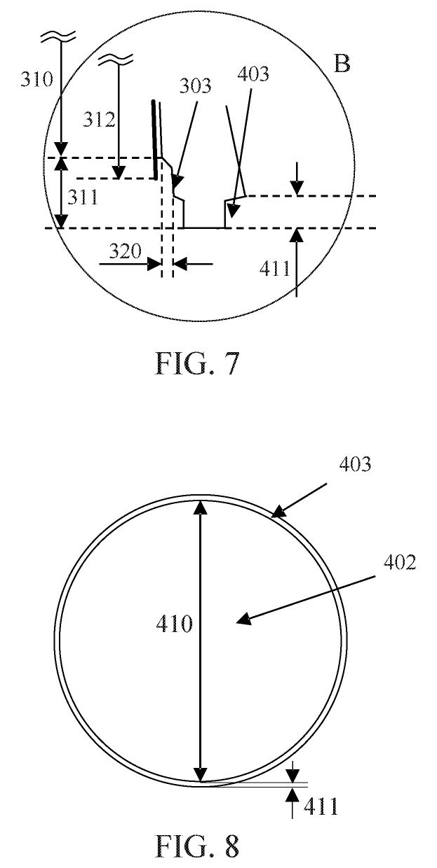

FIG. 7 is an enlarged view of the end B of the lens 301 illustrated in FIG. 6. The end of the R1 surface of the lens 301 has a step with a step height 320 in the optical axis direction at the boundary between the optically effective portion 302 and the ineffective portion 303. In this example, the step height 320 is set to 0.08 mm to prevent protrusions such as burrs generated during lens molding from coming into contact with the film 304. In FIG. 7, the diameter 312 of the film 304 is set to be larger than that of the optically effective portion 302 and to protrude into the ineffective portion 303. Thereby, the film 304 can be attached to the entire optically effective portion 302.

As described above, the optically effective portion 302 and the ineffective portion 303 are set to have different heights in the optical axis direction, so even if the lens 301 has protrusions such as burrs, the film 304 is prevented from riding up on the burrs, and causing the occurrence of a defective product such as a non-adhered portion of the film 304 or peeling of the film 304 from the optically effective portion 302.

If the height Ht (320) of the step between the optically effective portion 302 and the ineffective portion 303 in the optical axis direction is 0.08 mm as described above, and the lens thickness d is 1.8 mm, then Ht/d = 0.08/1.8 = 0.04, which satisfies the inequality 0.005 < Ht/d < 0.500. Thereby, the film 304 that is larger than the optically effective portion 302 to be attached.

A burr is generated in the optical axis direction on the lens 301 because resin flows between the mold that forms the optically effective portion 302 and the mold that forms the ineffective portion 303. Therefore, the outer circumferential portion (outer periphery) of the mold that forms the optically effective portion 302 may have a step. In this case, if the inequality 0.005 < Ht/d < 0.200 is satisfied, the step amount can be reduced, which is beneficial in terms of mold processing. In a case where the inequality 0.005 < Ht/d < 0.100 is satisfied, manufacturing becomes easier.

FIG. 8 illustrates the shape of the R2 surface. R2 surface includes, similarly to the R1 surface, an optically effective portion 402 and an ineffective portion 403. The optically effective portion 402 has a diameter 410 and the ineffective portion 403 has a width 411. A step is provided between the optically effective portion 402 and the ineffective portion 403 in the optical axis direction. Thereby, even if a burr is generated at the boundary between the optically effective portion 402 and the ineffective portion 403, the entire optically effective portion 402 can be used as an optical surface when the lens is cemented.

In a case where the radius of curvature is small, as in the case of the R1 surface of lens 301 in this example, the film 304 is to be stretched before being attached in order to prevent wrinkles in the film 304.

As described above, even if the lens 301 is a concave lens with a smaller radius of curvature, devising the shape of the lens 301 and the size of the film 304 can produce an inexpensive and small reflective polarizing film cemented lens without increasing the size of the lens 301.

### EXAMPLE 3

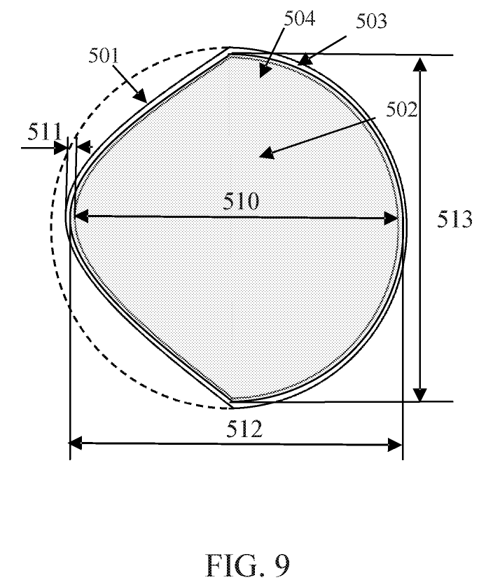

FIGS. 9 to 12 illustrate a lens 501 according to Example 3. This example differs from Example 2 in the shape of the lens 501, and the other configurations are the same as those of Example 2.

In FIG. 9, the lens 501 includes an optically effective portion 502 and an ineffective portion 503 on the lens surface. A reflective polarizing film 504 is attached to the surface of the lens 501. The reflective polarizing film 504 functions as a PBS that reflects P-polarized light and transmits S-polarized light. A minor axis 512 of the reflective polarizing film 504 is set to be larger than a minor axis 510 of the optically effective portion 502 and smaller than a minor axis of the lens 501.

A major axis 513 of the film 504 is also set to be larger than a major axis of the optically effective portion 502 and smaller than a major axis of the lens 501, just like the minor axis. In other words, the minor axis 512 of the film 504, the minor axis 510 of the optically effective portion 502, and the width 511 of the ineffective portion 503 may satisfy the following inequality: 510 < 512 < (510 + 511 + 511)

In this example, the shape of the noncircular portion is a spline shape, and the size in the minor axis direction is smaller than the size in the major axis direction.

This is to make it possible to wear the VR glasses closer to the face by reducing the relief portions that correspond to the nose and forehead when the viewer wears them. In this example, the relief portions are configured in a spline shape, but they may also be configured in a parabolic, elliptical, or polygonal shape.

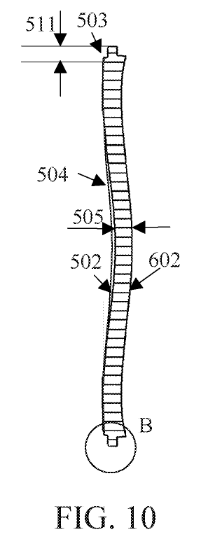

FIG. 10 is a schematic diagram of the cross section of the lens illustrated in FIG. 9. As in Example 2, lens 501 is a concave-convex lens, and is a resin lens with a radius of curvature R1=-38.1 mm near the center of R1 surface, a radius of curvature R2=-44.9 mm near the center of R2 surface, and a center thickness 505 of 1.8 mm. A reflective polarizing film 504 is cemented (attached) to the optically effective portion 502 of the R1 surface via an adhesive layer. As described above, the reflective polarizing film 504 is configured to have a larger diameter than the optically effective portion 502, and is cemented so that its end extends beyond optically effective portion 502. Reference numeral 602 denotes the optically effective portion of the R2 surface, and reference numeral 603 denotes the ineffective portion of the R2 surface. The R2 surface is a refractive surface with convex power, and an anti-reflection coating (not illustrated) is vapor-deposited on the surface.

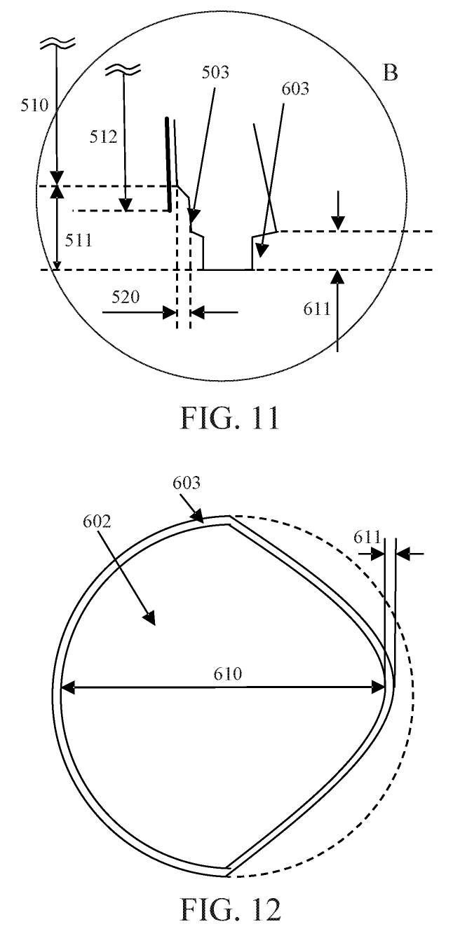

FIG. 11 is an enlarged view of the end B of the lens 501 illustrated in FIG. 10. The end of the R1 surface of the lens 501 has a step of a step height 520 in the optical axis direction at the boundary between the optically effective portion 502 and the ineffective portion 503. In this example, the step height 520 is set to 0.08 mm or more to prevent protrusions such as burrs generated during lens molding from coming into contact with the film 504.

In this example, since the outer shape of the lens 501 is rotationally asymmetric, the step height 520 differs in the major axis direction and the minor axis direction. The step height is configured to be the smallest in the major axis direction, and is set to 0.08 mm in the major axis direction. In FIG. 11, the diameter of the film 504 is larger than the optically effective portion 502, and the film 504 is configured to extend into the ineffective portion 503, so that the film 504 can be attached to the entire optically effective portion 502.

Thus, since the optically effective portion 502 and the ineffective portion 503 are different in height in the optical axis direction, even if the lens 501 has a burr or other protrusion, the film 504 is prevented from riding up on the burr, and causing the occurrence of a defective product, such as a non-adhered portion of the film 504 or peeling off from the optically effective portion 502.

If the step height Ht (520) in the optical axis direction between the optically effective portion 302 and the ineffective portion 303 is 0.08 mm and the thickness d of the lens 501 is 1.8 mm, Ht/d = 0.08/1.8 = 0.04, which satisfies the inequality 0.005 < Ht/d < 0.500. Thereby, the film 504 that is larger than the optically effective portion 502 of the lens 501 can be attached.

FIG. 12 illustrates the shape of the R2 surface. Similarly to R1 surface, the R2 surface also has a rotationally asymmetric shape and includes an optically effective portion 602 and an ineffective portion 603. The optically effective portion 602 has a minor axis 610, and the ineffective portion 603 has a width 611. A step is provided between the optically effective portion 602 and the ineffective portion 603 in the optical axis direction. Thereby, even if a burr is generated at the boundary between the optically effective portion 602 and the ineffective portion 603, the entire optically effective portion 602 can be used as an optical surface when the lens is cemented.

Here, the major axis is the longest axis passing through the center point calculated from the arc portion of each surface, and the minor axis is the shortest axis passing through the center point calculated from the arc portion. The major axis and the minor axis do not necessarily have to be perpendicular to each other. The surface to which the film is attached may be convex, and the opposite surface may be flat, convex, concave, or aspheric.

The outer circumferential portion (outer periphery) of the lens is an optically ineffective area, and is provided to serve as a release allowance during lens manufacturing, particularly when manufactured by injection molding. It may also be provided for mounting on the housing of an optical apparatus such as an HMD, and may be axially symmetric or asymmetric, regardless of whether it is a curved or flat surface. The outer circumferential portion may not extend over the entire circumference, and may only partially extend.

As described above, even with the rotationally asymmetric lens 501, devising the shape of the lens 501 and the size of the film 504 can produce an inexpensive and small reflective polarizing film cemented lens without increasing the size of the lens 501.

### EXAMPLE 4

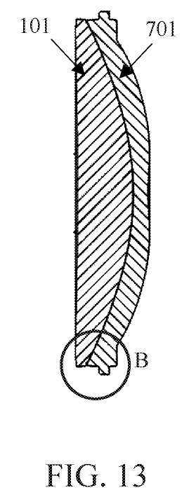

FIG. 13 illustrates a schematic cross-section of a lens according to Example 4. In FIG. 13, a lens 101 is a resin convex lens with a center thickness of 7.0 mm, and reference numeral 701 denotes a resin concave lens with a center thickness of 1.9 mm. The radius of curvature of the convex lens 101 near the optical axis (central axis) is R1 = -800 mm and R2 = -35.8 mm.

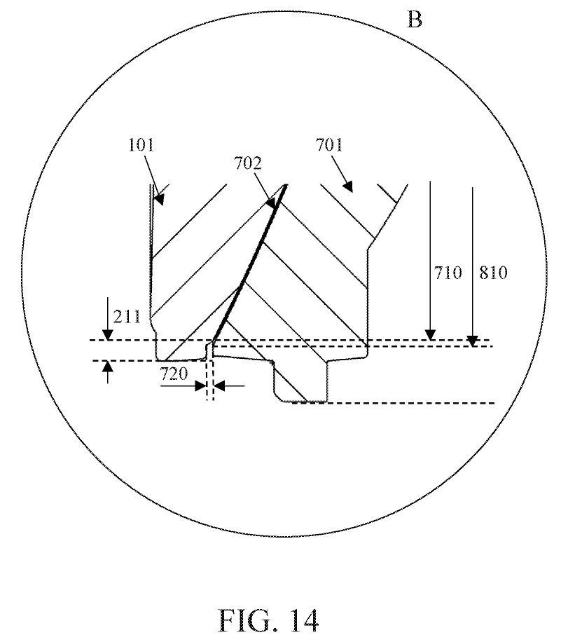

The concave lens 701 has radii of curvature R1 = -35.8 mm and R2 = 37.8 mm near the optical axis (central axis), and the R2 surface of the convex lens 101 and the R1 surface of the concave lens 701 are cemented together with an adhesive. FIG. 14 illustrates an enlarged view of an end B illustrated in FIG. 13. In FIG. 14, reference numeral 702 denotes the adhesive on the cementing surface.

The thickness of the adhesive 702 on the cementing surface is 20 μm. A diameter 810 of the optically effective portion of the R1 surface of the concave lens 701 is set to be larger than the diameter 710 of the optically effective portion of the R2 surface of the convex lens 101. Thereby, the concave lens 701 is cemented to the entire optically effective portion of the R2 surface of the convex lens 101 so that the diameter of the convex lens 101 can be made smaller.

A step height 720 in the optical axis direction is provided in the ineffective portion at the end of the cementing portion, so that cementing errors do not occur even if burrs occur at the end of the convex lens 101 in the optical axis direction. In this example, the step height 720 is set to 0.2 mm.

In this example, the concave lens 701 is made of resin, but the same effect can be obtained by using a glass lens.

As described above, when lenses are cemented, devising the shape of the lenses and making one lens larger than the other can produce an inexpensive and small cemented lens without increasing the size of the lens that is to be small.

### DISPLAY OPTICAL SYSTEM

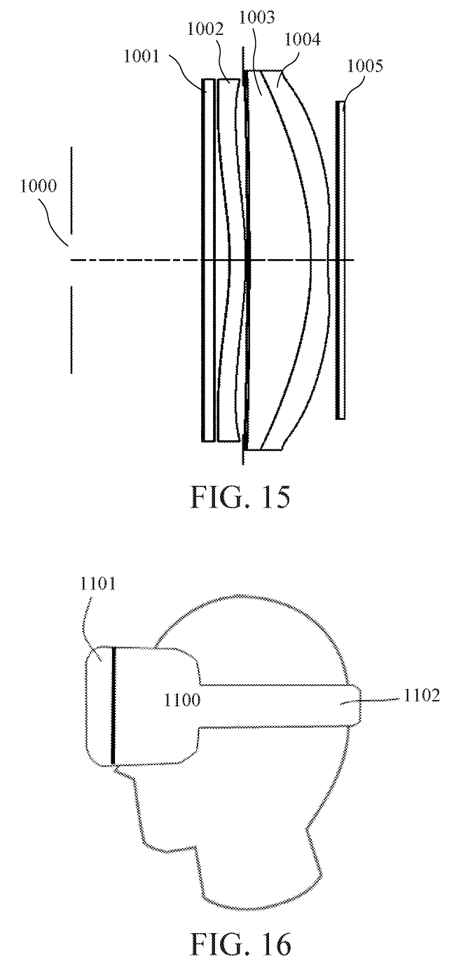

FIG. 15 illustrates a cross-section of a display optical system that uses any one of the lenses according to Examples 1 to 4. Reference numeral 1001 denotes a cover glass that is flat on both sides and has a linear polarizing film cemented to its surface. The cover glass 1001 also has the function of protecting a G1 lens 1002. This embodiment uses a glass cover member, but the same effect can be obtained by using a resin cover member.

Reference numerals 1002, 1003, and 1004 denote the G1 lens, a G2 lens (first optical element), and a G3 lens (third optical element), respectively. The G1 lens 1002 is a resin lens having refractive power, and the G2 lens 1003 and the G3 lens 1004 form a cemented resin lens having refractive power. A second optical element such as a PBS or a half-mirror is cemented or adhered to the surface of each lens. Thereby, the light from the display element 1005 can be guided to the pupil plane 1000 with a compact display optical system while performing good aberration correction.

### DISPLAY APPARATUS

FIG. 16 illustrates an HMD 1100 as an example of a display apparatus using the display optical system illustrated in FIG. 15.

The HMD 1100 includes a housing 1101, a wearing gear 1102, left-eye and right-eye display elements (1005 in FIG. 15), and a display optical system. A display unit that includes the display element and the display optical system is provided in the housing 10101. The HMD 1100 is attached to the user's head by the wearing gear 1102 so that the right-eye and left-eye display units are positioned for the left and right eyes of the observer, respectively.

An organic electroluminescence (EL) element, liquid crystal element, or the like is used as the display element 1005. The left-eye and right-eye display units display images for the left and right eyes, respectively.

According to the specifications of the HMD 1100, the display optical system may include a transmissive optical element such as a convex lens or concave lens, a reflective optical element such as a concave mirror, a mirror, a half-mirror, an optical path changing element such as a PBS, and the like. Although the HMD has been described here, optical elements can also be used for other display apparatuses such as projectors.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

Each example according to the disclosure can provide an optical element that has a reduced size and good optical performance.

This application claims the benefit of Japanese Patent Application No. 2024-189016, which was filed on October 28, 2024, and which is hereby incorporated by reference herein in its entirety.

What is claimed is:

1. An optical element comprising:
a first optical element; and
a second optical element that is a film,
wherein at least one surface of the first optical element has a first area as an optically effective portion and a second area as an ineffective portion, the optically effective portion being an effective diameter of a light ray to be actually used, and the ineffective portion being at least a part on an outer periphery side of the optically effective portion,
wherein the first area forms a cementing surface to which the second optical element is cemented, and
wherein the following inequality is satisfied:
C < D
where C is a size of the first area, and D is an external size of the second optical element.

2. The optical element according to claim 1, wherein the following inequality is satisfied:
C < D < (C + E)
where E is a size of the second area.

3. The optical element according to claim 1, wherein the following inequality is satisfied:
0-00.005 < Ht/d < 0.500
where Ht is a height of a step provided at a boundary between the first area and the second area, and d is a central thickness of the first optical element.

4. The optical element according to claim 1, wherein the second optical element includes a quarter waveplate.

5. The optical element according to claim 1, wherein the second optical element includes a reflective polarizing element.

6. The optical element according to claim 1, further comprising a third optical element cemented to the second optical element,
wherein each of the first optical element and the third optical element includes a resin lens having refractive power.

7. The optical element according to claim 1, wherein the second optical element includes a resin lens.

8. The optical element according to claim 1, wherein the second optical element includes a glass lens.

9. A display apparatus comprising:
an optical element; and
a display element that is a film,
wherein the optical element includes:
a first optical element; and
a second optical element,
wherein at least one surface of the first optical element has a first area as an optically effective portion and a second area as an ineffective portion, the optically effective portion being an effective diameter of a light ray to be actually used, and the ineffective portion being at least a part on an outer periphery side of the optically effective portion,
wherein the first area forms a cementing surface to which the second optical element is cemented, and
wherein the following inequality is satisfied:
C < D
where C is a size of the first area, and D is an external size of the second optical element.
